(19) United States
(12) Patent Application Publication
(10) Pub. No.: US 2017/0196209 A1
(43) Pub. Date: Jul. 13, 2017

(54) Blow Fish

(71) Applicant: Vincent F. Papagno, St. Petersburg, FL (US)

(72) Inventor: Vincent F. Papagno, St. Petersburg, FL (US)

(21) Appl. No.: 14/993,145

(22) Filed: Jan. 12, 2016

(51) Int. Cl. A01K 85/00

(52) U.S. Cl. CPC A01K 85/00

(57) ABSTRACT

The present invention is an electronically excited fishing lure apparatus that includes a main housing body portion defining an interior area. A battery is positioned in the interior area. A conductive interface is attached to the rechargeable battery. The electronically excited fishing lure apparatus generates an underwater signal that has random high and low frequency noise components that simulate sounds generated by the device. The signal attracts predatory fish to the electrical current by exciting the fishing lure apparatus.

### (B) CROSS REFERENCE TO RELATED APPLICATIONS

Not applicable.

### (C) FEDERALLY SPONSORED RESEARCH & DEVELOPMENT

Not applicable.

### (D) MICROFICHE APPENDIX

Not applicable.

### (E) BACKGROUND OF THE INVENTION

### (1) FIELD OF THE INVENTION

The present invention relates to fishing lures, and, more particularly, to fishing lures that are provided with an electrification apparatus to attract fish to the lure. The device is designed as an electronically excited lure with a specially developed fishing line to prevent attacks against game fishes by predatory fishes.

### (2) BACKGROUND OF THE INVENTION

Sport and commercial fishing are world-wide industries in which people of all skill levels participate. Throughout the world, anglers search for effective ways to find and catch fish. Fish are often found in certain areas of lakes, rivers, and streams that are difficult for anglers to position their lures into. Fishing has become a popular pastime and leisure activity, more so than merely a means for catching fish as a food source. Many people enjoy the challenge of hooking a fish and the relaxation of being in the outdoors around a lake, pond, or stream. One of the challenges of fishing has always been properly setting the hook when a nibble or bite on the bait or lure is detected. If the hook is not embedded deeply enough, the fish may be lost while being reeled in.

Devices have been previously developed in the art that attempt to more effectively embed a hook in a fish's mouth, such as multiple and complicated hook configurations. Although they are effective for their intended purposes, the existing devices do not make use of a fish's own energy to embed a hook member more deeply and securely upon receiving a lure into its mouth and moving away.

Some lures, such as U.S. Pat. No. 3,685,191, to Metzger, have fixed hooks, which may bend and break, allowing the fish to escape. Preferably, fishermen attach lures to their fishing line with a “leader,” often made from heavier fishing line.

For example, U.S. Pat. No. 2,552,730, to Miller, provides a leaf spring that vibrates when the fishing line is given a sudden jerk. However, since the spring vibrates in the water, the vibrations are of only short duration and, thus, only effective if a fish is in the immediate vicinity of the lure at the moment the spring is put in motion.

According to Pool & Spurgeon, U.S. Pat. No. 7,722,218 to Leung et al., and U.S. Pat. No. 7,240,453 to Safwat, some fish are attracted by a small electrical charge or electromagnetic impulses, probably similar to that emitted by their prey, and some lures of the prior art attempt to mimic this.

Fishermen have long known that certain predatory fish, including sharks, are attracted to the noises generated by propellers driving boats through the water. Additionally, it is known that fish are attracted by pulsed low frequency sound and fixed frequency sound that is transmitted underwater. Pulsed random noise signals have been broadcast underwater to attract fish.

Other objectives and features of the invention will become apparent as the description proceeds, especially when taken in conjunction with the accompanying drawings, which illustrate the invention, of which there are two sheets and one embodiment. Therefore, it would be desirable to have an electric shock fishing lure apparatus that energizes a hook member to shock a predatory fish when the predatory fish tugs on the hook member.

### (F) SUMMARY OF THE INVENTION

In view of the foregoing described and other obvious disadvantages inherent in the known types of electrically activated fishing lures present in the prior art, the present invention provides a new electrically activated fishing lure construction, wherein the same can be utilized to secure game fishes while fishing for various types of predatory fishes.

The general purpose of the present invention, which will be described hereafter in greater detail, is to provide a new electronic fishing lure apparatus and method that has many of the advantages of the electrically activated fishing lures mentioned above. It also includes novel features that result in a new electronically excited fishing lure that is not anticipated, rendered obvious, suggested, or even implied by any of the prior art related to electrically activated fishing lures, either alone or in any combination thereof.

The device of this invention includes a fishing lure that has audio, visual, and recording capabilities, wherein the user can see the fishing lure being devoured by predatory fish. The audio can also transmit a particular sound, created by the user, to aid in the attraction of other fish.

The electric fishing device is designed as an Electrically Excited Lure with a specially developed fishing line that incorporates the same thin fishing line and tasar circuit. Once the game fish is hooked onto the electrically excited lure, an electronic current is sent to the wire from a power source on the fishing vessel. The fish lure is attached to a simple trigger mechanism that forces a CO₂ cartridge into a pin, thereby allowing pressurized air to flow through a standard tire valve to inflate a long balloon down the fish's mouth into his stomach, thereby impeding its ability to effectively operate its gills to obtain oxygen, thus making the fish buoyant. This causes it to rise to the surface for easy retrieval

The device is easy to use, as this improved electric fishing lure is made by commercially available and inexpensive materials, such as a tasar, fishing line, and lure. There is also a hook member to shock a predatory fish when the predatory fish tugs on the hook member.

As described above, the functional aspects of the electric fishing lure has entertainment value as well as the ability to be used in biological and scientific applications in studying the feeding behavior of certain fish in aquatic environments.

The more important features of the invention have been broadly outlined in order that the detailed description thereof that follows may be better understood, and so that the present contribution to an improvement in the art may be better appreciated. There are additional features of the invention that will be described hereinafter, and will form the subject matter of the claims appended hereto.

Other features and advantages of the present invention will become more apparent from the following detailed description when taken in conjunction with the accompanying drawings, which illustrate, by way of example, the principles of the invention.

### (G) BRIEF DESCRIPTION OF THE DRAWINGS

To further clarify various aspects of some example embodiments of the present invention, a more particular description of the invention will be rendered by reference to specific embodiments thereof, which are illustrated in the appended drawings. It is appreciated that the drawings depict only illustrated embodiments of the invention, and are, therefore, not to be considered limiting of its scope. The invention will be described and explained with additional specificity and detail through the use of the accompanying drawings, in which:

FIG. 1 is a diagram illustrating the improved electronically excited lure of the present invention with an electrical wire fishing line,

FIG. 2 is a diagram illustrating the cross-sectional view of a first embodiment of the electric fishing lure of the present invention,

FIG. 3 is a diagram illustrating the pneumatic version of the present invention.

### (H) DETAILED DESCRIPTION OF THE INVENTION

The following detailed description refers to the accompanying drawings, which illustrate the embodiments of the present invention. Other embodiments are possible, and modifications may be made to the embodiments without departing from the spirit and scope of the invention. Therefore, the following detailed description is not meant to limit the invention. Rather, the scope of the invention is defined by the appended claims.

The term fishing is the act of catching fish in a variety of ways. Many ways of catching fish are available in an inexpensive manner. A fishing lure is a device that is designed to attract fishes by various methods. Consequently, various devices have been developed to aid fisherman in attracting fish to strike his or her lure. For example, some lures are provided with sound-producing means that emit high and low frequencies, which are attractive to game fish.

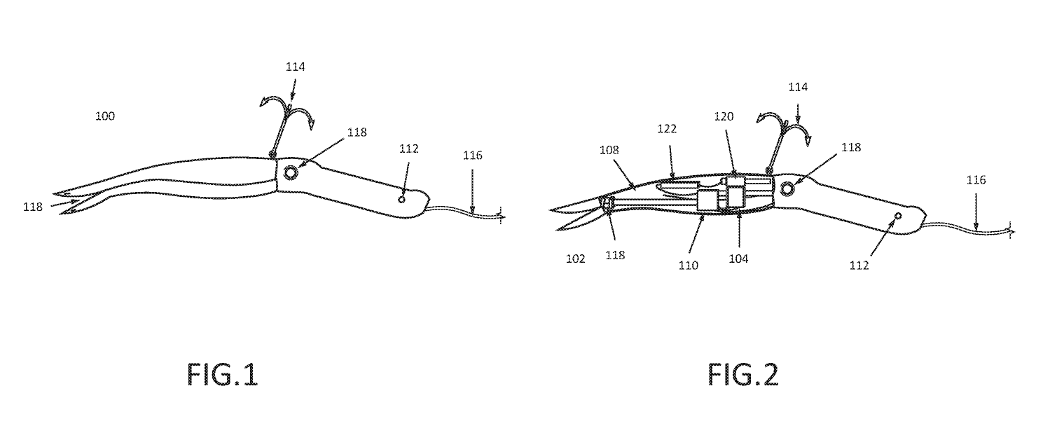

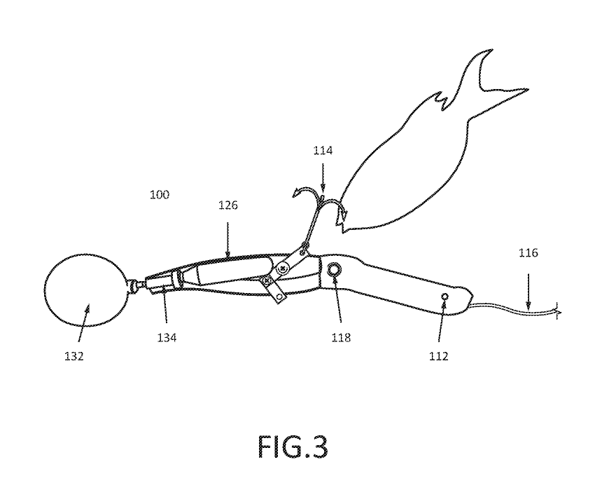

An electronically shocking fishing lure apparatus embodying the principles and concepts of the present invention will now be described in detail with reference to FIGS. 1 and 2 of the accompanying drawings.

FIGS. 1-2 illustrate an electronic fishing lure as contemplated by the present invention. The electronic fishing lure 100 is comprised of a body portion 108 formed to allow a fishing line 116 to be removable secured thereto, and means are provided for the attachment of at least one fishing hook 114 thereto. The hook 114 is connected to the fishing lure 100 and trigger, which releases a large spring that pushes a CO₂ cartridge 126 into a pin. The CO₂ inflates the balloon tail 132 of the fishing lure 100. The fishing line 116 can be secured to an eyelet secured to the front of the lure 100, as shown in the drawings. The main body portion 100 defines an interior space, so as to contain other components that will be described below. Two cameras 118 and 102 are attached to the front and tail portion of the fishing lure 100. A fishing line 116 is connected to the fishing rod. The CO₂ cartridge 126 works as a storage of sedative component for the predatory fishes. The body of the fishing lure 100 contains a rechargeable battery 104 that is connected to the electrical interface 110. A special and unique balloon tail 132 inflates into the mouth, throat, and stomach of the fish, which causes the fish to immediately float up to the surface for quick and easy retrieval. The purpose of the inflatable bottom tail is to deploy down the mouth of the fish by compressed air from the CO₂ cartridge 126, which is connected to the hook 114 via a trigger mechanism, as shown in the attached drawings. The working mechanism of the electronically excited fishing lures 100 with fishing line 116 incorporates the same thin wire technology and tasar circuit. Once the game fish is hooked on the fishing lure 100, an electrical current is sent down the wire from a power source.

The fish lure 100 is attached to a simple trigger mechanism that forces a CO₂ cartridge 126 into a pin, which allows pressurized air to flow through a standard tire valve 134 to inflate a long balloon down the fish's mouth into its stomach, thereby impeding its ability to effectively operate its gills to obtain oxygen, thus making the fish buoyant. This causes it to rise to the surface for easy retrieval

By incapacitating the game fish, it can be quickly reeled up and secured before it is attacked or killed by a predator fish or animal. If a predator fish attacks the game fish while it is hooked, another electrical charge is sent to discourage the predator from further attacks, thereby preserving the game fish unharmed for resale or release.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. A device that passively repells a predatory organism from a target organism by the use of an electronically excited lure, comprising:
a fishing lure body with a cavity;
a hook attached to the lure body;
an elongate battery;
a microphone/speaker;
an electrical Interface;
a fishing line;
a plurality of cameras;
photo-electric skin;
a balloon tail;
a CO₂ cartridge; and
a valve.

2. The device of claim 1, wherein said fishing lure body is connected to a fishing rod.

3. The device of claim 1, wherein said hook is attached to a mouth portion of said fishing lure body.

4. The device of claim 1, wherein the elongate battery is disposed within said cavity of the fishing lure.

5. The device of claim 1, wherein the elongate battery disposed within said cavity of the fishing lure is rechargeable.

6. The device of claim 1, wherein the microphone/speaker is used for transmitting or recording sound.

7. The device of claim 1, wherein the electrical interface is disposed within said cavity of the fishing lure.

8. The device of claim 1, wherein the fishing line is connected to a mouth portion of the fishing lure.

9. The device of claim 1, wherein two cameras are attached to a front and tail portion of an electronic fishing lure.

10. The device of claim 1, wherein said photo-electric skin is the outer surface of the electronic fishing lure.

11. The device of claim 1, wherein the bottom tail used for quick retrieval.

12. The device of claim 1, wherein CO₂ cartridge is connected to said hook.

13. The device of claim 1, wherein CO₂ cartridge is used to inflate the tail end of the lure to incapacitate, secure, or sedate the fish.

14. The device of claim 1, wherein the valve is used to inflate the balloon.

15. A method of passively repelling a predatory organism from a target organism by the use of an electronically excited lure providing an elongate lure body with a cavity, said method including:
providing an eccentrically weighted electrical current;
providing an elongate battery with a longitudinal axis substantially co-linear with the longitudinal axis of the lure body and the electric interface that is disposed within said cavity;
floating the fishing lure body in water such that the eccentric weighting of the electric interface lies in a surface plane of the water; and
providing the lure with circuitry configured to intermittently distribute power from the battery to the eccentrically weighted electric interface.

16. The method of claim 15, further comprising providing a bottom tail attached to the lure body.
